(19) United States
(12) Patent Application Publication
(10) Pub. No.: US 2026/0361689 A1
(43) Pub. Date: Nov. 12, 2026

(54) DATA LOSS PREVENTION IN A SECURE BROWSING ENVIRONMENT

(71) Applicant: Menlo Security, Inc., Mountain View, CA (US)

(72) Inventors: Christopher Staite, Bedfordshire (GB); Tomasz Pich, Southampton (GB); Ji Feng, Sunnyvale, CA (US); Lionel Litty, San Francisco, CA (US)

(21) Appl. No.: 19/205,995

(22) Filed: May 12, 2025

(51) Int. Cl. H04L 9/40

(52) U.S. Cl. CPC H04L 63/0245; H04L 63/04

(57) ABSTRACT

A security server executes a secure browser that acts as an intermediary between a local browser of a client device and a web server. The secure browser includes a page rendering module that loads web pages on behalf of the local browser and provides a rendered model of a web page to the local browser that avoids potentially malicious code from directly reaching the client device. The page rendering module furthermore obtains and processes browser interactions with the locally rendered web page to implement various browser functions. The secure browser includes a data loss prevention (DLP) module that intercepts operations of the page rendering module and triggers a DLP scan upon detecting a write operation. While the DLP scan is pending, subsequent operations are queued. The queued operations may be executed in time order upon completion of the DLP scan.

### BACKGROUND

### 1. Field of Invention

The disclosed embodiments relate generally to a secure browsing environment, and more specifically to data loss prevention (DLP) scanning in a secure browsing environment.

### 2. Description of Related Art

Enterprises and individuals face significant risk of data loss through users accidentally or carelessly sharing sensitive information through web browsers. Traditional network security solutions may employ DLP techniques through passive network scanning and/or through endpoint agents. These techniques seek to block communications of sensitive data to the Internet, but are typically limited to rudimentary checks on data transmitted during network requests. Such checks may fail to provide protection in scenarios in which the DLP scanner (1) does not sufficiently detect the sensitive nature of the data; and/or (2) does not sufficiently detect and block such transmissions before they occur. In modern web browsing, web applications may use a wide variety of application programming interfaces (APIs) that may transmit data according to API-specific protocols, store data for later transmission, and/or transform data in various ways. Such web applications may maliciously or accidentally employ techniques that can circumvent the basic protection mechanisms of traditional DLP scanners, thereby putting sensitive data at significant risk.

### BRIEF DESCRIPTION OF FIGURES

Non-limiting and non-exhaustive examples are described with reference to the following figures.

FIG. 1 is an example embodiment of a secure browsing environment.

FIG. 2 is a block diagram illustrating an example embodiment of an instance of a secure browser that facilitates DLP scanning.

FIG. 3 is an interaction diagram illustrating an example operation of a secure browser.

FIG. 4 is a flowchart illustrating an embodiment of a process for operating a secure browser that facilitates DLP scanning.

FIG. 5 is a block diagram illustrating an example embodiment of a local web browser that facilitates DLP scanning.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

In a secure browsing environment, a security server executes a secure browser that acts as an intermediary between a local browser of a client device and a web server. The secure browser includes a page rendering module that loads web pages on behalf of the local browser and provides a rendered model of the web page to the local browser that prevents potentially malicious code from directly reaching the client device. The page rendering module furthermore obtains and processes browser interactions with the locally rendered web page to implement various browser functions. From the user perspective, the rendered web page appears and interacts like web pages accessed during a conventional browsing experience.

To protect against loss of sensitive data, the secure browser includes a data loss prevention (DLP) module that asynchronously tracks user inputs entered in the local browser and can perform DLP scanning of the data prior to it being written externally. In one implementation, the page rendering module triggers a DLP scan upon detecting any write operation to any external interface, such as network requests to the external web server, transmissions associated with WebSockets or other persistent connections, writes to persistent storage outside of the web page (e.g., local storage), or other write operations associated with web applications. Whenever a DLP scan is triggered, the DLP scan is performed on all tracked user inputs. This ensures that user data can be comprehensively scanned for sensitive information even if a web application attempts to obfuscate the data before transmission, store it for later transmission, or employ other techniques to circumvent traditional data checks. While the DLP scan is pending, subsequent operations are queued to preserve time order. The queued operations may be executed from the queue in time order upon completion of the DLP scan.

The secure browser beneficially operates to protect the client device from malicious code and protects undesirable external transmission of sensitive data such as social security numbers, credit card numbers, health data, company trade secrets, or other sensitive data. The user may continue to interact with the page while scans are pending to avoid disruption. Moreover, the secure browser operates seamlessly in the background with minimal latency such that the user's browsing experience is similar to a conventional browsing experience.

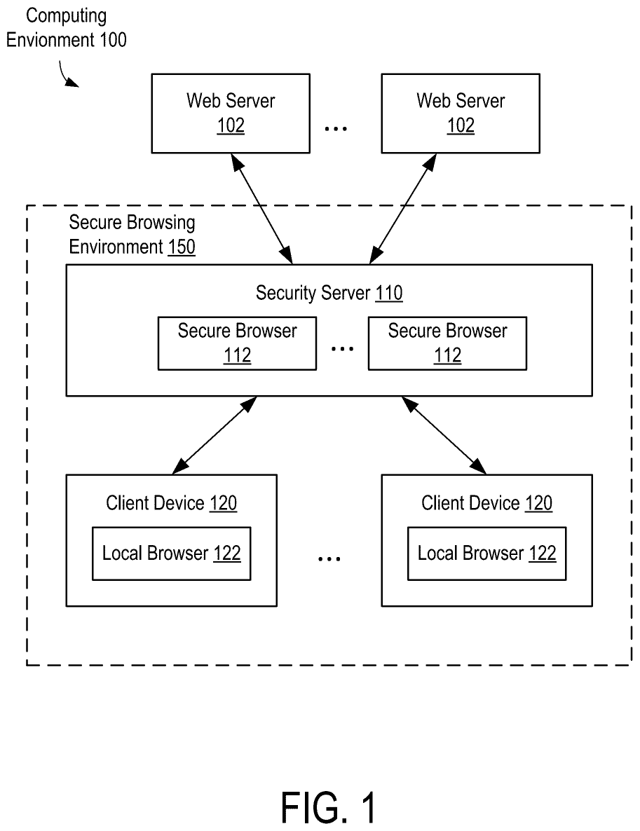

FIG. 1 illustrates an example computing environment 100 for secure web browsing. The computing environment 100 includes a secure browsing environment 150 in which a security server 110 acts as an intermediary between a set of client devices 120 and external web servers 102 to facilitate secure browsing of web content. The secure browsing environment 150 may be implemented in various contexts and configurations to provide enhanced security for web browsing activities. In some cases, the secure browsing environment 150 may be deployed within an enterprise network, offering protection for corporate devices and data. In other example, the secure browsing environment 150 may be deployed for education institutions or other organizations. In further examples, the secure browsing environment 150 may be deployed in association with a public network access point.

The web servers 102 may comprise any servers configured to host web pages, web applications, or other web-based resources that are accessible to web browsers over a network. The web servers 102 may utilize protocols such as hypertext transfer protocol (HTTP), secure hypertext transfer protocol (HTTPS), file transfer protocol (FTP), WebSocket protocols, Web Real Time Communication (WebRTC) Web Application Programing Interfaces (Web APIs) data channels, or other communication protocols for enabling interactions with a web browser. The web servers 102 may enable viewing and interactions with static web pages or may facilitate web applications that provide more complex dynamic functionality.

Web applications can present an elevated security risk in relation to protection of sensitive user data. For example, a malicious web application may cause a web browser to transmit sensitive user data (e.g., credit card information, social security numbers, etc.) over a persistent connection prior to the user expressly authorizing transmission (e.g., without the user expressly selecting a submission button or other action that triggers a network request). In another example, a web application may operate to store sensitive user data to a storage location on the client device 120 (or elsewhere in a network) and later transmit the sensitive data in encoded or encrypted form, such that traditional protection measures may not detect the sensitive nature of the data.

The client device 120 may include any type of computing device, such as a desktop computer, laptop, tablet, smartphone, or other devices capable of executing a local browser 122. The local browser 122 may be a conventional web browser application installed on the client device 120 and may be capable of typical browser functions such as rendering web pages, executing interactive web applications, and supporting various web technologies and protocols. The local browser 122 may support features like tabbed browsing, bookmarking, extensions, etc.

The security server 110 operates to protect the client devices 120 within the secure browsing environment 150 from malicious content arising from a web server 102 and also prevents the local browser 122 from transmitting certain sensitive data externally to the secure browsing environment 150. To facilitate these protections, the security server 110 intercepts communications to and from the local browser 122 and processes them in a secure browser 112, which executes in an isolated environment. In one implementation, the security server 110 may instantiate a secure browser 112 to facilitate secure browsing in association with each browsing session of a local browser 122 across all tabs and windows. In other implementations, a separate secure browser 112 may be instantiated for each unique tab or window of a local browser 112.

For web content accessed from a web server 102, the secure browser 112 processes the web page, generates a representation of the rendered web page, and provides only the rendered representation to the local browser 122. Potentially malicious code such as JavaScript, plug-ins, or malformed images are executed only in the secure browser 112, thereby protecting the local browser 122 and client device 120 from potentially malicious code and dramatically reducing the risk of malware infections, data breaches, and other security threats. From the user perspective, the rendered representation appears and interacts like the original web page. In an example implementation, the secure browser 112 may employ techniques for rendering web pages or facilitating other secure browser functions as described in U.S. Pat. No. 9,391,832 to Song, et al., which is incorporated by reference herein.

Operations performed by the secure browser 112 may include write operations or read operations. Write operations may include any operations that initiate outgoing network traffic, operations involving writing to storage persistent over a single page load, or operations involving transmitting data within the secure browser 112 or between secure browsers 112 (e.g., for data transferred between different tabs or pages of the local browser 122). Examples of write operations include performing network requests, communicating via WebSocket, WebRTC data channels, or other persistent connection, managing web cookies, writing to local storage, session storage, IndexedDB, WriteStreams, cross-frame postMessage, or service worker postMessage, performing write operations associated with HTML5 navigation, and/or any other functions that involve writing (including transmitting or storing) user data externally. Read operations may include operations involving receiving incoming network traffic, receiving data communicated within the secure browser 112 or between secure browsers 112 (e.g., for data transferred between different tabs or pages of the local browser 122). Read operations may similarly involve receiving data via network requests, communicating via WebSocket, WebRTC data channels, or other persistent connection, retrieving web cookies, reading from to local storage, session storage, IndexedDB, WriteStreams, cross-frame postMessage, or service worker postMessage, performing read operations associated with HTML5 navigation, and/or any other functions that involve retrieving various data from external sources. The secure browser 112 may also facilitate bidirectional communication operatons that are both a read operation and a write operation (e.g., network communications, postmessage communication, etc.)

The secure browser 112 may also operate to capture inputs entered to the rendered web page via the local browser 122 and check these inputs for sensitive information via a data loss prevention (DLP) scan before they are transmitted or stored. For example, a DLP scan may check for sensitive data such as social security numbers, credit card information, bank information, intellectual property information, healthcare data, or other sensitive information. Based on the results of the DLP scan, the secure browser 112 may allow the operation to proceed (if no sensitive data is found) or may block operations if sensitive data is found. The secure browser 112 may trigger the DLP scanning functionality after detecting write operations relating to various browser activity. In this manner, the secure browser 112 may detect and block transmission of sensitive data even in the presence of web applications that may utilize various browser API techniques to attempt to circumvent traditional DLP scanning. In some implementations, the scan may trigger immediately after each write operation. In other implementations, the scan may trigger after some cooldown delay period following a write operation. In this case, successive write operations that occur within the cooldown delay period may be batched together to trigger a single DLP scan.

The DLP scanning function may operate transparently in the background, such that from the user perspective, the secure browsing experience appears and functions the same as a conventional browsing experience. Moreover, by delaying the scan until a write operation is detected, the secure browser 112 may limit the number of scans performed and therefore reduce system load and increase overall performance.

In one implementation, the secure browsing environment 150 may include one or more network switch devices that operate to redirect traffic to or from the local browser 122 to the secure browser 112. In this implementation, the local browser 122 does not require any specialized extensions or configuration to enable interoperability with the secure browser 112. In another implementation, the client device 120 may include a browser extension or other local agent that redirects communications of the local browser 122 to the secure browser 112.

In one implementation, the security server 110 comprises a public or private cloud-based virtual machine that instantiates a secure browser 112 for each browsing session of a local browser 122 within the secure browsing environment 150. The same instantiated secure browser 112 may operate on all of the browser tabs and browser windows of a single user. The secure browser 112 may be shut down when the local browser is closed. Alternatively, a separate secure browser 112 may be instantiated for each page accessed in an individual tab or window of a local browser 122, and shut down upon closing the tab or window. These approaches enable flexibility and scalability of the secure browsing environments 150 while operating with low latency and enabling a seamless browsing experience. In another implementation, the security server 110 may be implemented as an on-premise enterprise server that coordinates with local network infrastructure (e.g., switches, firewalls, etc.) to facilitate redirecting of browser traffic through the security server 110. Various functions of the secure browser 112 may be implemented as instructions stored to a non-transitory computer-readable storage medium and executed by one or more processors.

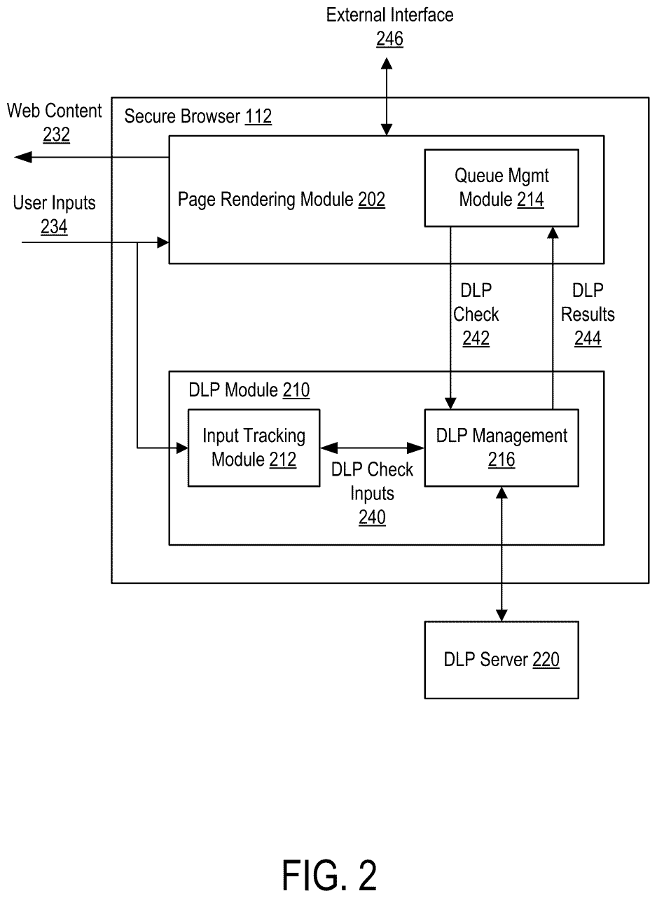

FIG. 2 illustrates a block diagram of an implementation of a secure browser 112. The secure browser 112 includes at least one page rendering module 202 that includes a queue management module 214, and a DLP module 210 that includes an input tracking module 212 and a DLP management module 216. Other variations of the secure browser 112 may include different or additional modules.

The page rendering module 202 handles retrieval and rendering of web content on behalf of a client device 120. When the client device 120 requests a web page, the page rendering module 202 communicates with the web server 102 via the external interface 246 to obtain the web page, processes the web page to render content similar to a conventional browser, and transmits the rendered output to the local browser 122 of the client device 120 as web content 232. In one implementation, the page rendering module 202 includes a dynamic transcoder that encodes a Document Object Model (DOM) layout of the rendered page and send DOM updates that describe the DOM of the page using a DOM update command language that communicates with a thin client layer of the local browser 122. The dynamic transcoder can also transcode resources such as images and CSS files into sanitized, canonicalized versions for the client devices 120 to download. Here, the dynamic transcoding may involve both DOM transcoding (to transcode the DOM) and resource transcoding (to transcode images and CSS). The local browser 122 interprets the DOM update commands and updates the DOM in the client browser accordingly.

The page rendering module 202 may also operate to perform browser-side functions associated with various web applications. This may involve performing actions such as storing and retrieving web cookies, writing to local storage, establishing persistent connections, implementing browser API functions, or performing other browser functions that involve reading or writing from the external interface 246. Users receive a seamless browsing experience through the streamed rendering data, interacting with the content as if it were processed locally, while benefiting from the added security and efficiency provided by this architecture.

The page rendering module 202 also operates to receive user inputs 234 from the local browser 122. These user inputs 234 may include keyboard entries, mouse clicks, touch gestures, pasting content, uploading files, or any other form of user interaction with the web page displayed in the local browser 122. The page rendering module 202 may process the inputs to update the rendered page (either directly or by relaying the inputs to the web server 102, local storage, or other external location via the external interface 246). From the user perspective, the local browser 122 responds to such user inputs 234 analogously to a conventional web browser.

The page rendering module 202 includes a queue management module 214 that operates trigger DLP checks 242 prior to writing (transmitting or storing) any user inputs 234 to the external interface 246. The queue management module 214 also operates to queue subsequent read or write operations issued while a DLP check is pending, and subsequently control execution of queued operations from the queue to maintain the operation order. When a read request is detected and no DLP check is pending, the queue management module 214 may allow the page rendering module 202 to directly issue the read operation to the external interface 246 without queuing. When a write operation 236 is identified, the queue management module may issue a DLP check 242 and queue the write operation and subsequent operations (read and write) in a time-ordered queue until the DLP results 244 are received. In some implementations, the queue management module 214 may immediately trigger a DLP check 242 after each received write operation. In other implementations, the queue management module 214 may wait a cooldown delay period before triggering a DLP check 242. In this approach, successive write operations within the cooldown period trigger only a single DLP scan, thereby limiting the number of independent DLP checks 242. The queue management module 214 may also issue additional DLP checks 242 if another write operation is intercepted while a DLP check 242 is pending. If the queue management module 214 receives a DLP result 244 indicating that a write operation is allowed, it may allow the write operation and any subsequent read operations or write operations that have already cleared the DLP check, while maintaining the time order of the queued operations. If a write operation in the queue still has a DLP check 242 pending, the queue management module 214 waits to receive the DLP results 244 for this write operation and continues to queue subsequent operations until the DLP results 244 are received. If a DLP result 244 indicates that sensitive data is present, the queue management module 214 may block the write operation(s) that triggered the scan, and may block subsequent read and write operations by the page rendering module 202. Furthermore, the page rendering module 202 may issue an alert to the local browser 122 to notify the user that further web application operations of the page will be blocked. However, the page rendering module 202 may preserve the previous state of the page up to the point of blocking such that the user may continue to view the page.

In one implementation, the page rendering module 202 may detect the read and write operations based on respective enumerated lists of operation types stored by the page rendering module 202. For example, the page rendering module 202 may maintain an enumerated list of operation types that are treated as write operations and an enumerated list of operation types that are treated as read operations. The lists may overlap for operations that are both read and write operations (e.g., operations associated with bidirectional communications). In alternative embodiments, the page rendering module 202 may identify write and/or read operations based on predefined characteristics or behaviors.

The DLP module 210 provides a layer of protection around the page rendering module 202 to implement DLP functionality. The DLP module 210 is generally designed to detect, monitor, and prevent the unauthorized transmission or exposure of sensitive data externally to the secure browsing environment 150. The DLP module 210 may thereby operate to protect confidential information from accidental or intentional leaks and ensure compliance with regulatory requirements and internal data security policies. Examples of sensitive information that may be protected by the DLP module 210 can include, for example, social security numbers, credit card information, bank information, intellectual property information, healthcare data, or other sensitive information.

The DLP module 210 operates to facilitate DLP checks whenever the page rendering module 202 attempts to write user data in the context of browser operations. The DLP module 210 may perform the DLP checks on all captured user inputs 234 from the local browser 122 to ensure robust scanning even when a malicious web application attempts to obfuscate data being transmitted to the web server 102 (e.g., by utilizing encryption or other techniques).

In one implementation, the DLP module 210 includes an input tracking module 212 and a DLP management module 216. Other embodiments may include additional or different modules.

The input tracking module 212 tracks the user inputs 234 entered into the local browser 122. In one implementation, the user inputs 234 may be tracked as an input stream representing the flow of data entries. For example, the user inputs 234 may be tracked as a sequence of input events, which may include keyboard presses, mouse movements, mouse clicks, touch screen interactions, or other input events. This approach allows the input tracking module 212 to account for various types of inputs such as deletions, cut/paste operations, and/or cursor repositioning. In other embodiments, the input tracking module 212 may capture a sequence of static snapshots of the user inputs 234 entered into a web page without necessarily capturing each input event separately. For example, static snapshots may be captured at periodic intervals or upon a trigger event. The input tracking module 212 may capture inputs asynchronously with respect to network requests, such that the input tracking module 212 provides real-time monitoring of the user inputs 234.

The DLP management module 216 operates to facilitate the DLP checks 242 requested from the queue management module 214 and issue the DLP results 244 to the queue management module 214 for completed DLP checks 242. The DLP management module 216 may obtain the input data 240 from the input tracking module 212 and whenever a DLP check request 242 is received, facilitate a DLP check on the cumulative input data tracked during the browsing session. For example, the queue management module 214 may initiate a DLP scan of the tracked input stream captured during the browsing session up to the point of the write operation. In one implementation, the DLP management module 216 may obtain an index for each requested DLP check 242 and then return this index with the DLP results 244 to enable tracking of DLP checks.

The DLP management module 216 may coordinate with an external DLP server 220 (e.g., accessible over a network) to perform the DLP checks. In one implementation, the DLP server 220 may employ a rule-based approach that applies a set of rules to the input data 240 to identify sensitive inputs that should be blocked. For example, the rules may be configured to scan for certain patterns in inputs consistent with sensitive data such as social security numbers, credit card numbers, etc. Furthermore, the DLP server 220 could perform certain keyword searches to identify inputs containing keywords indicative of sensitive data. In further embodiments, the DLP server 220 may utilize machine learning techniques or other advanced language processing techniques to detect sensitive information based on various sensitivity criteria. The specific DLP scanning rules may be configurable to an administrator of an organization associated with the secure browsing environment 150, such that the DLP server 220 operates in accordance with organization-specific policies. In an alternative embodiment, the DLP server 220 may operate within the secure browsing environment 150 and may be integrated directly with the DLP management module 216.

The above-described operation of the DLP module 210 ensures that the input data 240 provided to the DLP server 220 for scanning corresponds to the original user input, rather than the data in the write request. This approach ensures that malicious web applications cannot circumvent detection by encrypting or otherwise obfuscating the user inputs 234 in the write requests. Furthermore, the asynchronous queuing mechanism employed by the DLP module 210 avoids excessive latency by only queueing operations when a DLP scan is pending. The secure browser 112 may therefore maintain responsiveness while still providing robust data loss prevention.

In an example implementation, the secure browser 112 may instantiate a page rendering module 202 per origin (e.g., host domain, protocol, and/or port). Multiple pages from the same origin may be served by the same page rendering module 202, while pages from different origins are served by separate page rendering modules 202. The DLP module 210 may be instantiated per user, such that pages from different origins are served by the same DLP module 210. In this case, the DLP scans may be performed based on collective user inputs 234 entered across multiple pages. For scalability and flexibility, the page rendering modules 202 and DLP module 210 may be dynamically instantiated and shut down in response to the browsing activity in the local browser 122.

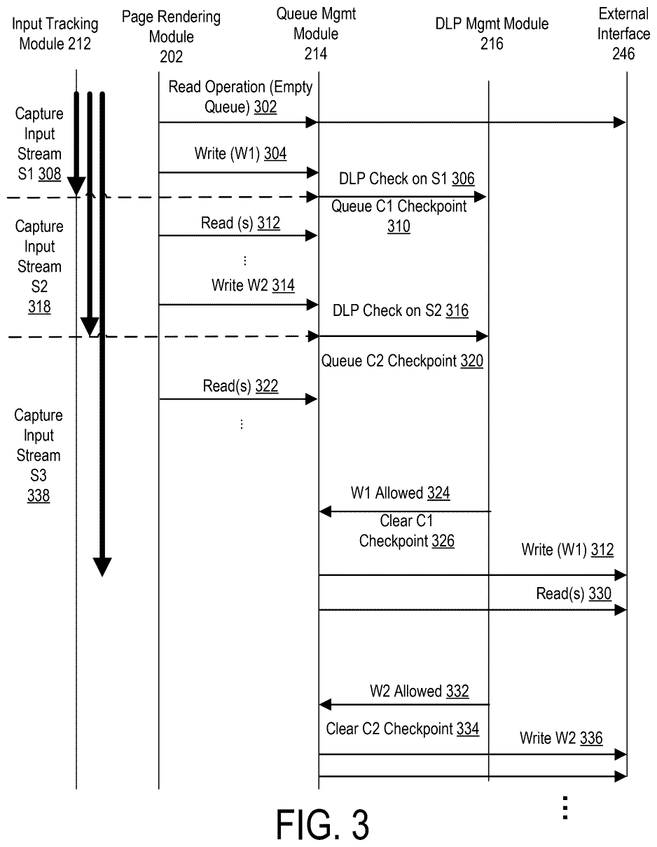

FIG. 3 is a timing diagram indicative of an example operation of the queuing mechanism of the secure browser 112. In this example, the queue is initially empty and the page rendering module 202 issues a read operation 302. Since there are no queued requests, the read operation can be issued directly to the external interface 246 without corrupting the time order of the requests. Next, in this example, a first write operation (W1) 304 is issued and intercepted by the queue management module 214. This triggers a DLP check 306 on the input stream (S1) 308, which represents the cumulative user inputs captured up until this DLP check 306 is triggered. The DLP check 306 creates a first checkpoint (C1) 310 after which subsequent operations are queued until the DLP check 306 on the input stream (S1) 308 is resolved. The checkpoint (C1) 310 may be expressly stored (e.g., as a flag) or may comprise an implicit checkpoint identified by the write operation in the queue. In implementations where a cooldown delay period is implemented, the DLP check 306 may be delayed until the after the cooldown delay period (during which other successive write operations may occur), and the input stream (S1) may include the cumulative input stream until the end of the cooldown delay period. The subsequent operations that get queued may include one or more read operations 312 and/or one or more write operations (e.g., a second write operation (W2) 314). The second write operation (W2) 314 may trigger another DLP check 316 (either immediately or after a cooldown delay period), this time on an input stream (S2) 318, which represents the cumulative user inputs captured before issuance of this DLP check 316. The second write operation (W2) results in a second checkpoint (C2) 320. After this, additional read operations 320 may continue to be queued. Additional write operations (not shown) may result in yet further DLP checks and additional associated queueing checkpoints.

Upon completion of the DLP scan for the first write operation (W1) 304, the queue management module 214 obtains a DLP scan result indicating the first write operation (W1) 304 is allowed 324. The DLP scan result effectively clears the first checkpoint C1 326 such that all queued operations up to the next uncleared checkpoint may be proceed in time order. For example, the queue management module 214 may proceed to issue the allowed write operation (W1) 328 and the subsequently queued read 330 up until the second checkpoint (C2) 320 that is not yet cleared. The queue management module 214 then waits for the second DLP check results associated with the second write operation (W2) 314 before proceeding further.

The second write operation (W2) is subsequently allowed 332, thus clearing the second checkpoint (C2) 320 and allowing the second write operation (W2) to proceed 336. Meanwhile, the input tracking module 212 continues to track inputs received after the second checkpoint (C2) 320 in a third input stream (S3) 338 that will be scanned upon the next write operation being issued.

While in the illustrated example, the second DLP check 316 is not allowed 332 until after the first DLP check 306 is cleared, it is possible that the scans could complete out of order. In that case, the second checkpoint (C2) 320 may already be cleared 334 when the first write operation (W1) is allowed 324, and thus the second write operation (W2) may be issued 336 without further delay after issuing all prior operations. As an additional optimization, if the second input stream (S2) 318 is only additive to the first input stream (S1) 308 and the second DLP check 316 completes first, then the first checkpoint (C1) 310 may be automatically cleared without expressly waiting for the first DLP check 306 to complete.

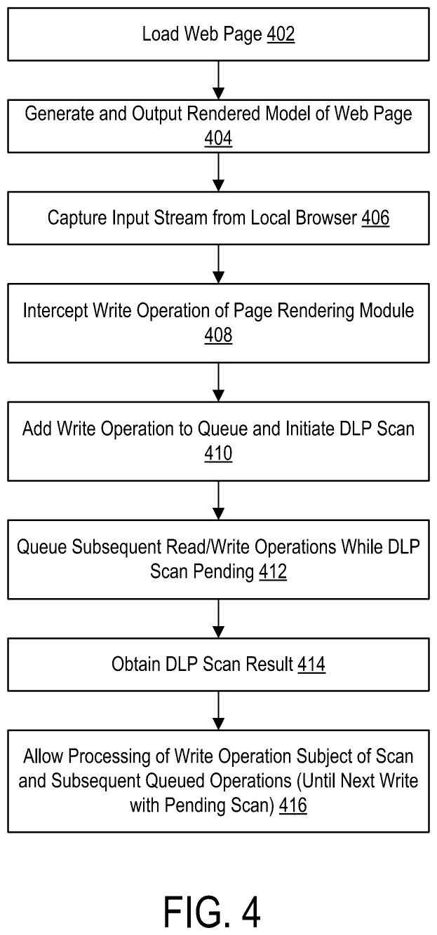

FIG. 4 is an example embodiment of a flowchart illustrating operation of the secure browser 112 according to the principles described herein. The secure browser 112 loads 402 a web page requested from a local browser 122 of a client device 120. The secure browser 112 generates and outputs 404 a rendered model of the web page to the local browser 122. As a user interacts with the local browser 122, the secure browser 112 captures 406 an input stream comprising input events entered into the web page at the local browser 122. The inputs may be captured as they are entered into the local browser 122 asynchronously with respect to network requests. The secure browser 112 intercepts 408 a write operation of a page rendering module 202. The write operations may include any operations that initiate outgoing network traffic, operations involving transmitting data to another page rendering module 202 associated with the local browser 122, or operations involving writing to storage persistent over a single page load. Examples of write operations include performing network requests, communicating via WebSocket, WebRTC data channels, or other persistent connection, managing web cookies, writing to local storage, session storage, IndexedDB, WriteStreams, cross-frame postMessage, or service worker postMessage, performing write operations associated with HTML5 navigation, and/or any other functions that involve writing (including transmitting or storing) user data externally. The secure browser 112 adds the write operation to an operation queue and initiates 410 a DLP scan of the input stream captured prior to initiating the DLP scan. The secure browser 112 queues 412 (to the operation queue) subsequent read or write operations that are intercepted from the page rendering module 202 while the DLP scan is executing (i.e., to prevent out of order execution) Here, read operations may include operations involving receiving incoming network traffic, receiving data communicated within the secure browser 112 or between secure browsers 112 (e.g., for data transferred between different tabs or pages of the local browser 122). The secure browser 112 may subsequently obtain 414 a result of the DLP scan. If the result of the DLP scan indicates that the write operation is allowed, the secure browser 112 416 allows processing of the write operation that was subject to the DLP scan and the subsequent read or write operations from the operation queue (up until a next write operation associated with a pending DLP scan). The subsequent operations may be executed in order of receipt to maintain time ordering. However, if there are subsequent write operations that have been queued for which DLP checks are not yet resolved, further execution will be paused until the next scan is completed. If a DLP check instead indicates that the write is not allowed (e.g., because the input stream contains sensitive data), any further write operations may be blocked and the user may be alerted.

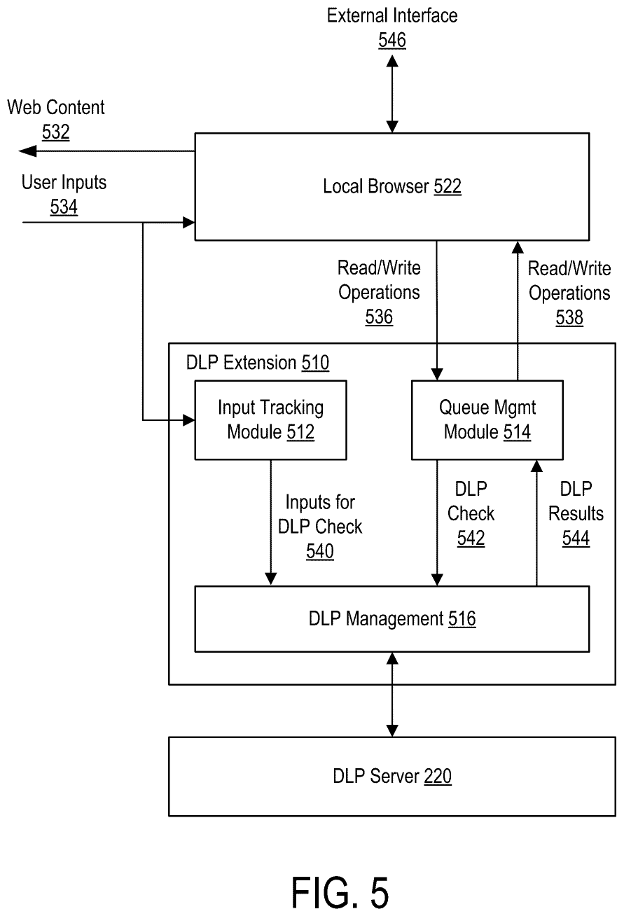

FIG. 5 illustrates an embodiment of a local web browser 522 that incorporates DLP scanning functions via a DLP extension 510. Unlike the secure browsing environment 150 of FIG. 1, the local web browser 522 of FIG. 5 may operate as a standalone browser that does not necessarily interact with a secure browser 112, but may implement DLP scanning via a DLP browser extension 510. In this embodiment, the local browser 522 performs conventional browsing functions (e.g., to obtain user inputs 534 and output web content 532). The local browser 522 may furthermore execute Javascript or other embedded code, execute web applications, and perform other browser functions, and may directly output web content 532 on the client device 120.

The DLP extension 510 may operate to perform functions similar to the queue management module 214 and the DLP module 210 described above. For example, the DLP extension 510 may include a queue management module 514 that operates to intercept read/write operations 536 from the local browser 522, manage a queue of operations while a DLP scan in pending, and output read/write operations 538 from the queue as DLP scans are completed. The queue management module 514 may furthermore issue DLP checks 542 to a DLP management module 516 and obtain results 544 of the scans. The input tracking module 512 may track user inputs 534 and provide tracked inputs 540 to the DLP management module 516 for scanning. The DLP management module 516 may coordinate with a DLP server 220 to facilitate DLP scanning on the inputs 540 when a DLP check 542 is requested, and return the DLP results 544 to the queue management module 514 when scans are complete. Alternatively, the DLP management module 516 may directly perform the DLP scans, in which case the connection to the external DLP server 220 may be optionally omitted. Thus, the DLP extension 510 may facilitate DLP scans similarly to the queue management module 214 and DLP module 210 described above, except that the DLP extension 510 may be installed directly with a local browser 522 on a client device 120 instead of executing as a component of a secure browser 112 on a security server 110.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible non-transitory computer readable storage medium or any type of media suitable for storing electronic instructions and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

1. A method performed by a security server operating a secure browser, comprising:
loading, by a secure browser, a web page requested from a local browser of a client device;
generating, by a page rendering module of the secure browser, a rendered model of the web page;
outputting the rendered model to the local browser of the client device;
capturing, from the local browser of the client device, an input stream comprising input events entered into the web page at the local browser;
intercepting a write operation of a page rendering module of the secure browser;
adding the write operation to an operation queue, and initiating a data loss prevention (DLP) scan of the input stream captured prior to initiating the DLP scan;
queuing to the operation queue, subsequent read or write operations intercepted from the page rendering module while the DLP scan is executing;
obtaining a result of the DLP scan; and
responsive to the result of the DLP scan indicating that the write operation is allowed, allow the page rendering module to process the write operation and allowing the page rendering module to process the subsequent read or write operations in the operation queue up until a next write operation associated with a pending DLP scan.

2. The method of claim 1, wherein the input events are captured by the secure browser asynchronously to network requests of the secure browser.

3. The method of claim 1, wherein the write operation comprises at least one of: an operation that initiates outgoing network traffic, an operation involving transmitting data to another page rendering module serving the local browser, and an operation that writes to storage persistent over a single page load.

4. The method of claim 1, wherein the read operation comprises at least one of: an operation that obtains incoming network traffic, an operation involving receiving data from another page rendering module serving the local browser, and an operation that reads from storage persistent over a single page load.

5. The method of claim 1, further comprising:
responsive to the result of the DLP scan indicating that the write operation is not allowed, blocking the write operation and the read or write operations in the operation queue.

6. The method of claim 5, further comprising generating an alert to the local browser to alert a user that the write operation has been blocked.

7. The method of claim 1, wherein the DLP scan comprises applying one or more rules to detect sensitive data in the input stream.

8. The method of claim 7, wherein the sensitive data comprises at least one of: credit card numbers, social security numbers, or confidential enterprise data.

9. The method of claim 1, further comprising:
intercepting a read operation of the page rendering module while no DLP scan is pending; and
allowing the page rendering module to execute the read operation to execute without queuing.

10. The method of claim 1, wherein the secure browser is implemented in a virtual machine instance that is instantiated for each web page accessed by the local browser.

11. The method of claim 10, further comprising shutting down the virtual machine instance when the web page is closed by the local browser.

12. A non-transitory computer-readable storage medium storing instructions for performed by a security server operating a secure browser, the instructions when executed by one or more processors causing the one or more processors to perform steps including:
loading, by a secure browser, a web page requested from a local browser of a client device;
generating, by a page rendering module of the secure browser, a rendered model of the web page;
outputting the rendered model to the local browser of the client device;
capturing, from the local browser of the client device, an input stream comprising input events entered into the web page at the local browser;
intercepting a write operation of a page rendering module of the secure browser;
adding a write operation to an operation queue, and initiating a data loss prevention (DLP) scan of the input stream captured prior to initiating the DLP scan;
queuing to the operation queue, subsequent read or write operations intercepted from the page rendering module while the DLP scan is executing; and
obtaining a result of the DLP scan; and
responsive to the result of the DLP scan indicating that the write operation is allowed, allow the page rendering module to process the write operation and allowing the page rendering module to process the subsequent read or write operations in the operation queue up until a next write operation with a pending DLP scan.

13. The non-transitory computer-readable storage medium storing instructions of claim 12, wherein the input events are captured by the secure browser asynchronously to network requests of the secure browser.

14. The non-transitory computer-readable storage medium storing instructions of claim 12, wherein the write operation comprises at least one of: an operation that initiates outgoing network traffic, an operation involving transmitting data to another page rendering module serving the local browser, and an operation that writes to storage persistent over a single page load.

15. The non-transitory computer-readable storage medium of claim 12, wherein the read operation comprises at least one of: an operation that obtains incoming network traffic, an operation involving receiving data from another page rendering module serving the local browser, and an operation that reads from storage persistent over a single page load.

16. The non-transitory computer-readable storage medium storing instructions of claim 12, wherein the instructions when executed further cause the one or more processors to perform a step of:
responsive to the result of the DLP scan indicating that the write operation is not allowed, blocking the write operation and the read or write operations in the operation queue.

17. The non-transitory computer-readable storage medium storing instructions of claim 16, further comprising generating an alert to the local browser to alert a user that the write operation has been blocked.

18. The non-transitory computer-readable storage medium of claim 12, wherein the DLP scan comprises applying one or more rules to detect sensitive data in the input stream.

19. The non-transitory computer-readable storage medium storing instructions of claim 12, wherein the instructions when executed further cause the one or more processors to perform steps including:
intercepting a read operation of the page rendering module while no DLP scan is pending; and
allowing the page rendering module to execute the read operation to execute without queuing.

20. A method performed by a local browser of a client device that includes a data loss prevention (DLP) scanning browser extension, the method comprising:
loading a web page by the local browser;
capturing, by the DLP scanning browser extension, an input stream comprising input events entered into the web page at the local browser;
intercepting, by the DLP scanning browser extension, a write operation of the local browser;
adding, by the DLP scanning browser extension, the write operation to an operation queue, and initiating a data loss prevention (DLP) scan of the input stream captured prior to initiating the DLP scan;
queuing to the operation queue, subsequent read or write operations intercepted from the local browser while the DLP scan is executing;
obtaining, by the DLP scanning browser extension, a result of the DLP scan; and
responsive to the result of the DLP scan indicating that the write operation is allowed, allow, by the DLP scanning browser extension, the local browser to process the write operation and allowing the local browser to process the subsequent read or write operations in the operation queue up until a next write operation associated with a pending DLP scan.
